(19) United States
(12) Patent Application Publication
(10) Pub. No.: US 2020/0072716 A1
(43) Pub. Date: Mar. 5, 2020

(54) CHAIN MONITORING SYSTEM

(71) Applicant: NAKANISHI METAL WORKS CO., LTD., Osaka (JP)

(72) Inventors: Yoshihiro OKAZAKI, Osaka (JP); Tomonari SHIBAYAMA, Osaka (JP); Yuji SEKINO, Osaka (JP)

(21) Appl. No.: 16/549,716

(22) Filed: Aug. 23, 2019

(30) Foreign Application Priority Data
Sep. 3, 2018 (JP) 2018-164477

(51) Int. Cl. G01N 3/08

(52) U.S. Cl. CPC G01N 3/08; G01N 27/9026

(57) ABSTRACT

A chain abnormality detection device provided at a predetermined location on a circulation path of an endless chain includes a measurement start position detector, a reference position detector, and a distance measurement unit. The measurement start position detector detects that a measurement start position comes to a first predetermined position, and the reference position detector detects a timing when a reference position comes to a second predetermined position. The distance measurement unit measures a distance from the reference position to a subsequent reference position, at each of the timings. A difference calculator is provided which calculates a difference between the distance measured at the present time and the distance measured at the previous time, for the same reference position, and a breakage determination unit is provided which determines whether there is partial breakage, on the basis of the difference calculated by the difference calculator.

### BACKGROUND OF THE INVENTION

### Field of the Invention

The present invention relates to a chain monitoring system for chain equipment including an endless chain formed by connecting a plurality of links, and a drive device therefor, and relates in particular to the chain monitoring system for monitoring the state of the endless chain by a chain abnormality detection device provided at a predetermined location on a predetermined circulation path while the endless chain is circulating along the circulation path.

### Description of the Background Art

One example of chain monitoring systems for detecting breakage of an endless chain detects stoppage of a chain of a sludge scraper when the chain is completely broken due to corrosion, wear, external force, or the like, and issues an alarm and stops a drive motor (see, for example, Patent Literature 1).

One example of chain monitoring systems for detecting an abnormal state that leads to complete breakage, before an endless chain is completely broken, is configured such that, for a conveyor chain used for an automobile coating line or the like and formed by connecting center links and side links with pins, damage (partial breakage) of one side (one connection portion) of the center link due to fatigue is directly detected, thus preventing the chain from being completely broken (see, for example, Patent Literature 2).

### SUMMARY OF THE INVENTION

The chain monitoring system (damage detection device 1 for conveyor chain) in Patent Literature 2 includes detection units 3, 4 provided respectively for the right and left sides and disposed with an interval therebetween in the movement direction of a conveyor chain 2 so as to be opposed to side portions of the chain 2.

The detection units 3, 4 each include a permanent magnet 5, and an induction coil 8 is wound around one of iron materials 6, 7 attached to both poles of the magnet 5.

The magnet 5 and a nonconductor member 9 that covers the end side of each of the iron materials 6, 7 are fixed on a movable base 10.

The movable base 10 is provided on a fixed base 11 and guided by guide rails 12 so as to be movable in a direction perpendicular to the chain 2.

The movable base 10 is urged toward the chain 2 by a coil spring 13, and an oil damper 14 acts on the side opposite to the chain 2. Therefore, the chain 2 is constantly in close contact with the nonconductor member 9, and the distance between the chain 2 and each detection unit 3, 4 is kept approximately constant.

A pair of right and left photoelectric tubes 15, one of which is a light projector and the other one of which is a light receiver, are disposed with the chain 2 interposed therebetween. The photoelectric tubes 15 perform detection of a check timing and reset of a counter.

When the chain 2 moves, center links 21 and side links 22 of the chain 2 alternately pass through a magnetic field, to cause change in a magnetic flux, and an induced electromotive force due the change is detected by the detection units 3, 4. In the case where one connection portion of the center link 21 is broken, the induced electromotive force to be detected as described above occurs one more time when the broken part passes through the magnetic field. Thus, it is possible to directly detect that one side (one connection portion) of the center link 21 is damaged (partially broken).

However, the chain monitoring system as shown in Patent Literature 2 has a large-scale configuration in which the two detection units 3, 4 provided on both sides of the conveyor chain 2 are each provided with the permanent magnet 5, the iron materials 6, 7, the induction coil 8, the nonconductor member 9, the movable base 10, the fixed base 11, the guide rails 12, the coil spring 13, the oil damper 14, and so on. Therefore, a large installation space is needed on both right and left sides of the chain 2, and the manufacturing cost increases.

In addition, the nonconductor members 9 of the detection units 3, 4 need to be in close contact with the moving chain 2. This causes wear of the nonconductor members 9, for example, to occur, so that the maintenance cost increases.

Furthermore, although partial breakage of the center link 21 of the chain 2 can be detected, it is impossible to detect breakage of one of a pair of upper and lower side links 22, 22.

In view of the above circumstances, an object to be achieved by the present invention is to provide a chain monitoring system that requires a reduced installation space and is capable of detecting not only partial breakage of a center link but also breakage of one of a pair of upper and lower side links, without increasing the manufacturing cost or the maintenance cost.

The summary of the present invention is as follows.

[1] A chain monitoring system for chain equipment including an endless chain formed by connecting a plurality of links, and a drive device therefor, the chain monitoring system being configured to monitor a state of the endless chain by a chain abnormality detection device provided at a predetermined location on a predetermined circulation path while the endless chain is circulating along the predetermined circulation path,

the chain abnormality detection device including a measurement start position detector, a reference position detector, and a distance measurement unit,

the measurement start position detector being configured to detect that a measurement start position of the endless chain comes to a first predetermined position,

the reference position detector being configured to detect that one of measurement reference positions of the endless chain comes to a second predetermined position,

the distance measurement unit being configured to measure a distance from the measurement reference position to a subsequent measurement reference position, every time the reference position detector detects that the measurement reference position comes to the second predetermined position,

the chain monitoring system including:
a storage configured to store the distance measured by the distance measurement unit, for each of the measurement reference positions;
a difference calculator configured to calculate a difference between the distance measured at a present time and the distance measured at a previous time and/or a time prior thereto, for the same measurement reference position; and
a breakage determination unit configured to determine whether partial breakage has occurred in the endless chain, on the basis of the difference calculated by the difference calculator.

[2] A chain monitoring system for chain equipment including an endless chain formed by connecting a plurality of links, and a drive device therefor, the chain monitoring system being configured to monitor a state of the endless chain by a chain abnormality detection device provided at a predetermined location on a predetermined circulation path while the endless chain is circulating along the predetermined circulation path,

the chain abnormality detection device including a measurement start position detector, a reference position detector, and a distance measurement unit,

the measurement start position detector being configured to detect that a measurement start position of the endless chain comes to a first predetermined position,

the reference position detector being configured to detect that one of measurement reference positions of the endless chain comes to a second predetermined position,

the distance measurement unit being configured to measure a distance from the measurement reference position to a subsequent measurement reference position, every time the reference position detector detects that the measurement reference position comes to the second predetermined position,

the chain monitoring system including:
a storage configured to store the distance measured by the distance measurement unit, for each of the measurement reference positions, and store an initial distance which is the distance when the endless chain initially circulates in the chain equipment; and
a breakage determination unit configured to determine whether partial breakage has occurred in the endless chain, on the basis of the distance measured at a present time and the initial distance, for the same measurement reference position.

[3] The chain monitoring system according to [1], in which

the chain abnormality detection device is provided at a location that is upstream of and near a tension maximum part where tension acting on the endless chain is maximized, in the endless chain.

[4] The chain monitoring system according to [2], in which

the chain abnormality detection device is provided at a location that is upstream of and near a tension maximum part where tension acting on the endless chain is maximized, in the endless chain.

[5] The chain monitoring system according to [3], in which

the chain abnormality detection device is provided at a location that is upstream of and near a driven part of the endless chain driven by the drive device, in the endless chain.

[6] The chain monitoring system according to [4], in which

the chain abnormality detection device is provided at a location that is upstream of and near a driven part driven by the drive device, in the endless chain.

[7] The chain monitoring system according to [1], in which

the endless chain includes:
center links which are oblong annular members or bar-shaped members each having, at front and rear ends, pin holes penetrating therethrough in a vertical direction;
pairs of upper and lower side links which are plate-shaped members each having, at front and rear ends, pin holes penetrating therethrough in the vertical direction; and
connection pins connecting the center links and the pairs of upper and lower side links, and

the measurement reference position is a front end of each of the center links.

[8] The chain monitoring system according to [2], in which

the endless chain includes:
center links which are oblong annular members or bar-shaped members each having, at front and rear ends, pin holes penetrating therethrough in a vertical direction;
pairs of upper and lower side links which are plate-shaped members each having, at front and rear ends, pin holes penetrating therethrough in the vertical direction; and
connection pins connecting the center links and the pairs of upper and lower side links, and

the measurement reference position is a front end of each of the center links.

[9] The chain monitoring system according to [1], in which

the breakage determination unit determines whether partial breakage has occurred in the endless chain, on the basis of a rate of change in the difference calculated by the difference calculator.

[10] The chain monitoring system according to [3], in which

the breakage determination unit determines whether partial breakage has occurred in the endless chain, on the basis of a rate of change in the difference calculated by the difference calculator.

[11] The chain monitoring system according to [5], in which

the breakage determination unit determines whether partial breakage has occurred in the endless chain, on the basis of a rate of change in the difference calculated by the difference calculator.

[12] The chain monitoring system according to [7], in which

the breakage determination unit determines whether partial breakage has occurred in the endless chain, on the basis of a rate of change in the difference calculated by the difference calculator.

[13] The chain monitoring system according to [1], in which

the chain equipment further includes an automatic oil supplier configured to supply oil to the endless chain when a rate of change in the difference calculated by the difference calculator is a predetermined value or greater.

[14] The chain monitoring system according to [3], in which

the chain equipment further includes an automatic oil supplier configured to supply oil to the endless chain when a rate of change in the difference calculated by the difference calculator is a predetermined value or greater.

[15] The chain monitoring system according to [5], in which

the chain equipment further includes an automatic oil supplier configured to supply oil to the endless chain when a rate of change in the difference calculated by the difference calculator is a predetermined value or greater.

[16] The chain monitoring system according to [7], in which

the chain equipment further includes an automatic oil supplier configured to supply oil to the endless chain when a rate of change in the difference calculated by the difference calculator is a predetermined value or greater.

[17] The chain monitoring system according to [9], in which

the chain equipment further includes an automatic oil supplier configured to supply oil to the endless chain when a rate of change in the difference calculated by the difference calculator is a predetermined value or greater.

The chain monitoring system according to the present invention as described above mainly provides effects as described below.

(1) The chain abnormality detection device provided at the predetermined location on the circulation path of the endless chain in the chain equipment can be configured with a compact and simple structure. Therefore, the installation space of the chain monitoring system is reduced and increase in the manufacturing cost can be suppressed.

(2) Contactless sensors which are not in contact with the endless chain are used as the sensors of the chain abnormality detection device, thereby also suppressing increase in the manufacturing cost.

(3) The chain abnormality detection device includes the measurement start position detector, the reference position detector, and the distance measurement unit. These are used for measuring the link lengths of the endless chain for the respective link numbers sequentially, and the breakage determination unit is used for determining whether or not partial breakage has occurred in the endless chain. Thus, it is possible to detect partial breakage of the center link and partial breakage of a pair of side links.

(4) The chain abnormality detection device is provided at a location that is upstream of and near a tension maximum part where tension acting on the endless chain is maximized, in the endless chain, whereby extension of the link length due to wear and extension of the link length due to partial breakage are clearly discriminated from each other and partial breakage of the endless chain can be reliably detected.

### BRIEF DESCRIPTION OF THE DRAWINGS

FIG. 1 is a schematic plan view showing a chain monitoring system according to an embodiment of the present invention;

FIG. 2 is an exploded perspective view of an endless chain;

FIG. 3 is a perspective view of a chain abnormality detection device;

FIG. 4 is a partial vertical sectional view of a chain abnormality detection device as seen from the front side;

FIG. 5 is a front perspective view showing a sensor of the chain abnormality detection device;

FIG. 6 is a front view of the chain abnormality detection device;

FIG. 7 is a plan view showing a partially broken center link that is taken out; and

FIG. 8 is a graph showing the relationship between a link number and a difference in the link length.

### DESCRIPTION OF THE PREFERRED EMBODIMENTS

Hereinafter, an embodiment according to the present invention will be described with reference to the drawings.

In the following embodiment, the advancing direction of an endless chain is defined as frontward direction, the direction opposite thereto is defined as rearward direction, the right and the left are defined with respect to the frontward direction, and a view as seen from the left side is defined as front view.

<Chain Equipment>

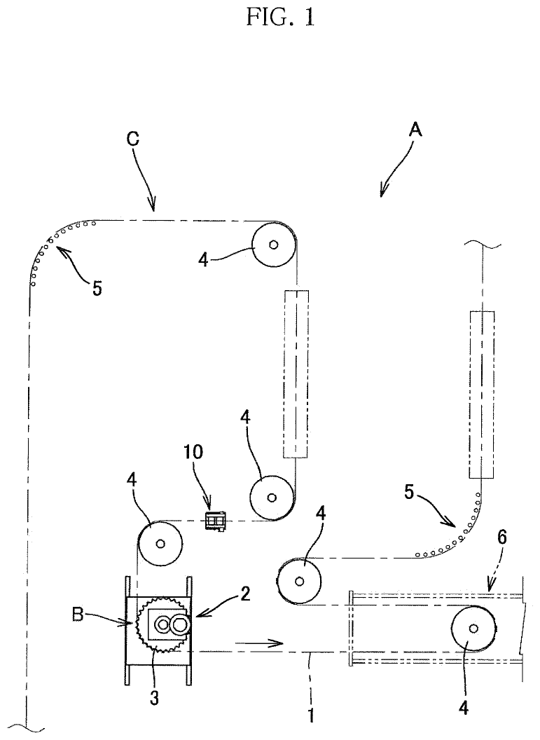

In chain equipment A shown in a schematic plan view in FIG. 1, an endless chain 1 is stretched on a drive sprocket 3 of a drive device 2, wheel turns 4, and roller turns 5, and is provided with tension by a tensioner 6. The endless chain 1 advances in a direction of an arrow in the drawing, so as to circulate through a predetermined circulation path C.

The chain equipment A is provided with a chain monitoring system for monitoring the state of the endless chain 1 by a chain abnormality detection device 10.

In the present invention, the chain equipment A is preferably applied to a conveyance line for automobile, for example, and the endless chain 1 is preferably applied to a conveyor chain used for the conveyance line for automobile, and more preferably applied to a rivet-less chain.

In such chain equipment A, the endless chain 1 on which tension is acting bends repeatedly, and stress acts on the endless chain 1 repeatedly. Accordingly, due to fatigue, partial breakage on one side of a center link or breakage of one of a pair of upper and lower side links occurs. Even in the case where such breakage has occurred, the chain equipment A can be operated without any problem for a certain period.

As used herein, the term “partial breakage” of the endless chain 1 includes “partial breakage” on one side of the center link of the endless chain 1 and “breakage” of one of a pair of upper and lower side links of the endless chain 1, i.e., “partial breakage” of the pair of upper and lower side links.

The chain monitoring system detects the partial breakage of the endless chain 1, before the endless chain 1 is completely broken to cause the chain equipment A to be unable to operate. This makes it possible to replace the center link or the side link that has been partially broken. Thus, the chain equipment A is prevented from becoming unable to operate as a result of complete breakage of the endless chain 1.

Replacement of the partially broken link is performed in a state where the endless chain 1 is stopped after the partially broken link is moved to a position where tension acting on the endless chain 1 is minimized, for example.

<Chain Monitoring System>

In the chain monitoring system according to the embodiment of the present invention, the state of the endless chain 1 is monitored by the chain abnormality detection device 10 provided at a predetermined location on the circulation path C while the endless chain 1 is circulating along the circulation path C in the chain equipment A.

As described later, the chain abnormality detection device 10 detects the length of each link and performs determination as to partial breakage on the basis of change in the length due to the partial breakage. Therefore, the chain abnormality detection device 10 is provided at a location where tension acting on the endless chain 1 is expected to be a certain value or higher. This is for clearly discriminating between extension of the link length due to wear and extension of the link length due to partial breakage.

Therefore, preferably, the chain abnormality detection device 10 is provided at a location that is upstream of and near a tension maximum part where tension acting on the endless chain 1 is maximized in the endless chain 1.

The tension acting on the endless chain 1 for clearly discriminating between extension of the link length due to wear and extension of the link length due to partial breakage, is appropriately determined in accordance with the type, the material, or the like of the endless chain.

For example, the chain equipment A in the present invention may be a conveyance line for automobile. In such a situation, if the chain abnormality detection device 10 is provided at a location where tension acting on the endless chain 1 is 2000 N or greater, it is possible to clearly discriminate between extension of the link length due to wear and extension of the link length due to partial breakage. If the chain abnormality detection device 10 is provided at a location where the tension is 5000 N or greater, it is possible to more clearly discriminate between extension of the link length due to wear and extension of the link length due to partial breakage.

In particular, as shown in FIG. 1, it is more preferable that the chain abnormality detection device 10 is provided at a location that is upstream of and near a driven part B of the endless chain 1 driven by the drive device 2, in the endless chain 1. Accordingly, the chain abnormality detection device 10 is located near the drive device 2 for which inspection is needed, and thus it is possible to effectively perform inspection or the like of the chain abnormality detection device 10.

(Endless Chain)

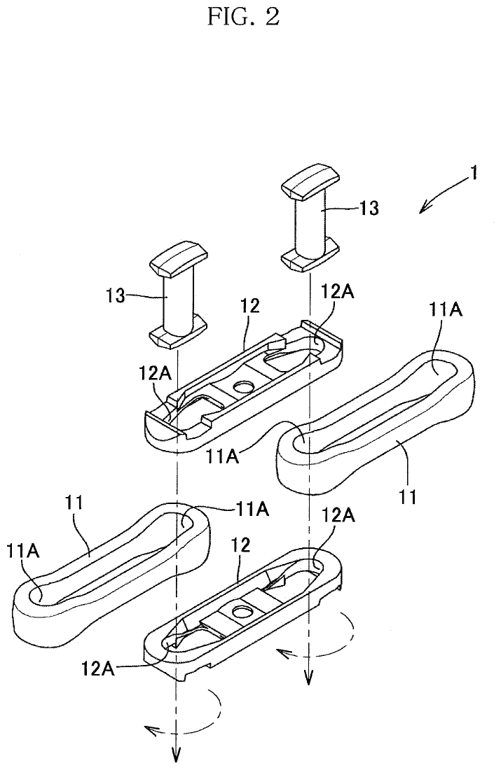

As shown in an exploded perspective view in FIG. 2, the endless chain 1 includes, for example, center links 11, a pair of upper and lower side links 12 and connection pins 13.

Each center link 11 is an oblong annular member having, at front and rear ends, pin holes 11A penetrating therethrough in the vertical direction. The center link 11 may be a bar-shaped member having, at front and rear ends, the pin holes 11A penetrating therethrough in the vertical direction.

Each side link 12 is a plate-shaped member having, at front and rear ends, pin holes 12A penetrating therethrough in the vertical direction.

The connection pins 13 are inserted through the pin holes 12A of one side link 12, the pin holes 11A of the center links 11, and the pin holes 12A of the other side link 12, and turned by 90 degrees, whereby the center links 11 and the pair of upper and lower side links 12 are connected to each other.

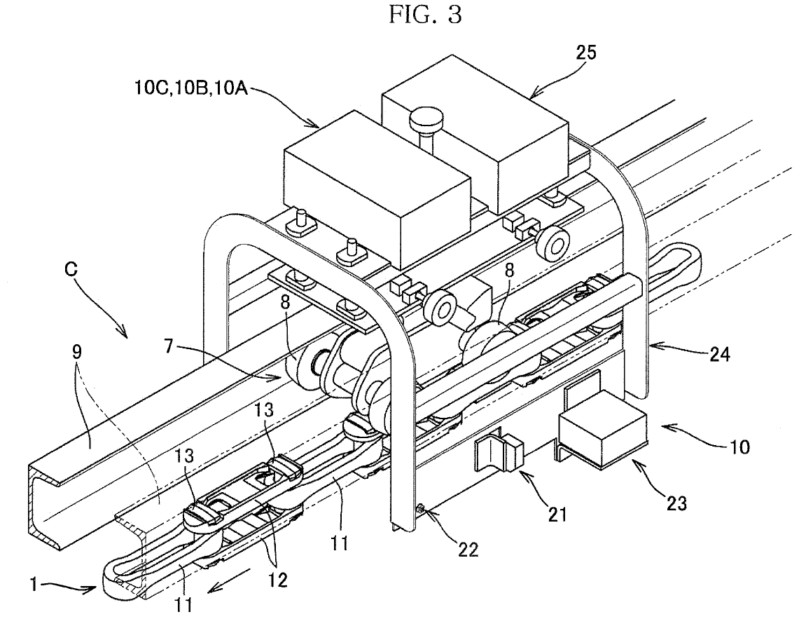

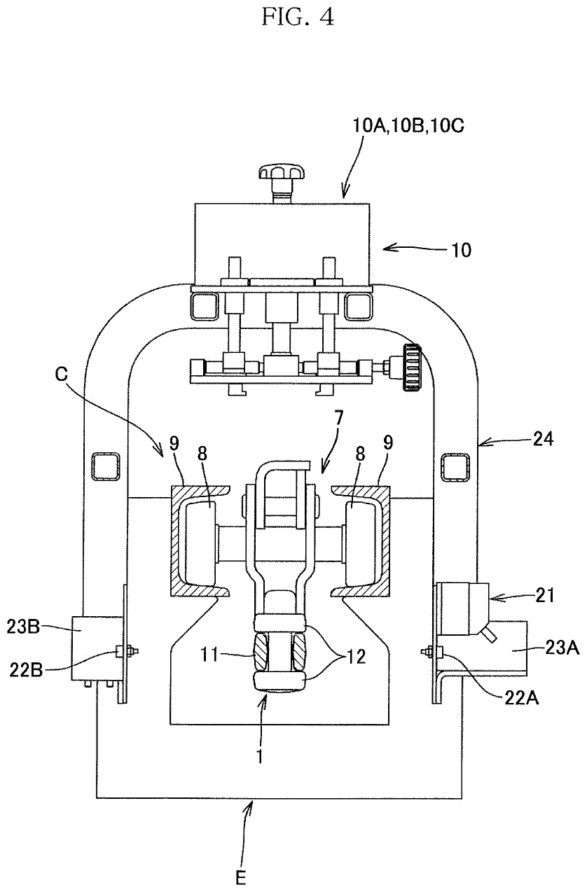

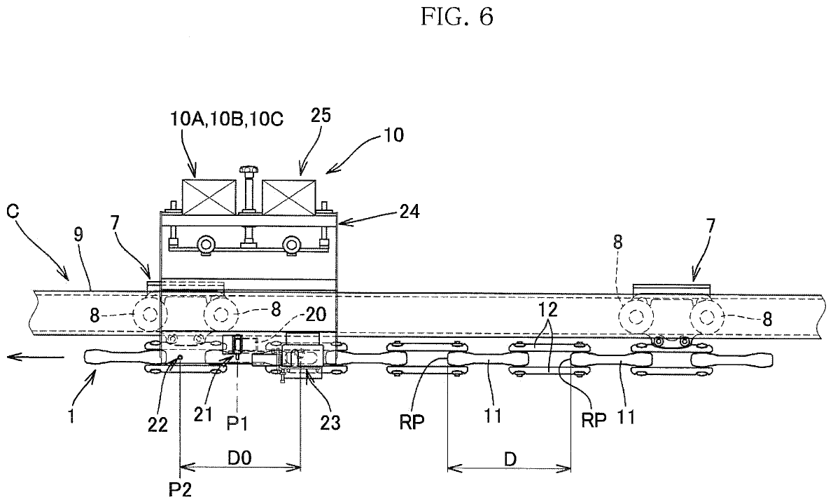

As shown in a perspective view in FIG. 3 and a front view in FIG. 6, trolleys 7 are mounted to the endless chain 1, and right and left traveling rollers 8 of each trolley 7 are supported by guide rails 9 supported by a yoke E (see FIG. 4).

As shown in a perspective view in FIG. 3 and a partial vertical sectional view in FIG. 4, the guide rails 9 are a pair of right and left channel steels having substantially U-shaped cross sections and provided so as to be spaced from each other in the right-left direction, with their opened sides opposed to each other. However, a single guide rail formed from an I-shaped steel may be used, and the traveling rollers may be engaged with the right and left sides of the guide rail.

(Configuration of Chain Abnormality Detection Device)

As shown in the perspective view in FIG. 3, the partial sectional view in FIG. 4, and the front view in FIG. 6, the chain abnormality detection device 10 is supported by a support member 24, and includes a reflection-type photoelectric sensor 21 which is a measurement start position detector, a transmission-type photoelectric sensor 22 which is a reference position detector, a laser-type CCD length-measurement sensor 23 which is a distance measurement unit, and a sensor controller 25 which includes amplifiers for these sensors, and the like.

Further, the chain abnormality detection device 10 includes a transmission/reception unit 10A, a control unit 10B, and a storage 10C.

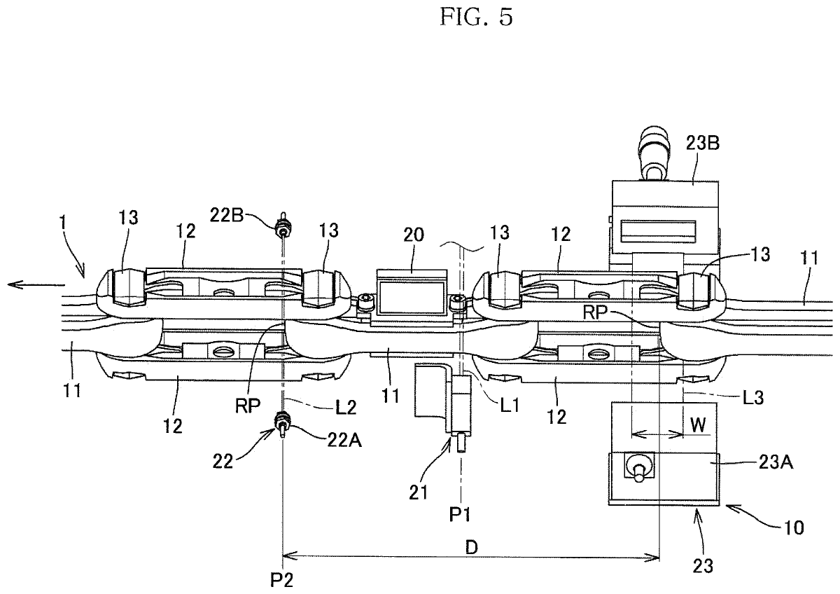

The reflection-type photoelectric sensor 21 projects light L1 (see FIG. 5) to a detection object, and receives reflected light therefrom, to detect the detection object.

The transmission-type photoelectric sensor 22 includes a light projector 22A and a light receiver 22B provided so as to be opposed to each other. The transmission-type photoelectric sensor 22 projects light L2 (see FIG. 5) from the light projector 22A to the light receiver 22B and detects blockage of the light L2 by the object passing between the light projector 22A and the light receiver 22B.

The laser-type CCD length-measurement sensor 23 includes a light projector 23A and a light receiver 23B. The laser-type CCD length-measurement sensor 23 projects light L3 (see FIG. 5) having a measurement width W, from the light projector 23A to the light receiver 23B, and detects, at a predetermined timing, the position in the advancing direction of an object while the object is passing between the light projector 23A and the light receiver 23B and blocking the light L3.

As shown in a front perspective view in FIG. 5 and the front view in FIG. 6, the reflection-type photoelectric sensor 21 which is the measurement start position detector is provided at a first predetermined position P1, and the transmission-type photoelectric sensor 22 which is the reference position detector is provided at a second predetermined position P2 which is downstream of the first predetermined position P1.

The laser-type CCD length-measurement sensor 23 which is the distance measurement unit is provided such that the center of the measurement width W is located at a position that is separated upstream from the second predetermined position P2 by an initial link length (distance from a measurement reference position RP of the center link 11 to a measurement reference position RP of the subsequent center link 11) D0 (see FIG. 6) at a time when the endless chain 1 is initially mounted in the chain equipment A, for example.

For the arrangement of the laser-type CCD length-measurement sensor 23 at the position separated from the second predetermined position P2 by the predetermined distance D0, positioning is performed in advance by using a reference plate that defines the distance, or the like.

(Operation of Chain Abnormality Detection Device: Measurement of Link Length)

A reflection plate 20 for defining a measurement start position is mounted to the endless chain 1. The reflection-type photoelectric sensor 21 which is the measurement start position detector projects light L1, and receives reflected light from the reflection plate 20, to detect the reflection plate 20. The link number of the corresponding center link 11 at this time is defined as 1.

The transmission-type photoelectric sensor 22 which is the reference position detector projects light L2, and the timing when blockage of the light L2 by the measurement reference position RP which is the front end of the center link 11 is detected is used as a trigger for the laser-type CCD length-measurement sensor 23 which is the distance measurement unit.

As shown in FIG. 5, at the above timing, the laser-type CCD length-measurement sensor 23 detects the position of the measurement reference position RP which is the front end of the subsequent center link 11 while the measurement reference position RP of the subsequent center link 11 is blocking the light L3, whereby the distance D from the measurement reference position RP to the subsequent measurement reference position RP, i.e., the link length can be measured for each link number in the ascending order from the number 1 sequentially.

Thereafter, when the reflection plate 20 on the endless chain 1 is detected by the reflection-type photoelectric sensor 21, measurement for the link lengths of all the links of the endless chain 1 has been completed and thus the measurement is finished.

The link lengths measured for the respective link numbers are stored into the storage 10C.

(Operation of Chain Abnormality Detection Device: First Breakage Determination Method)

The controller 10B of the chain abnormality detection device, or a controller of a server device that has received the link lengths transmitted from the transmission/reception unit 10A, includes a difference calculator and a breakage determination unit.

The difference calculator calculates a difference between the link length measured at the present time and the link length measured at the previous time and/or a time prior thereto, for the same measurement reference position RP.

The breakage determination unit determines whether or not partial breakage has occurred in the endless chain 1, on the basis of the difference calculated by the difference calculator.

Here, the breakage determination unit may determine whether or not partial breakage has occurred in the endless chain 1, on the basis of the rate of change in the difference calculated by the difference calculator.

(Operation of Chain Abnormality Detection Device: Second Breakage Determination Method)

The storage 10C also stores an initial link length D0 at a time when the endless chain 1 is initially circulated in the chain equipment A.

The controller 10B of the chain abnormality detection device 10, or the controller of the server device that has received the link lengths transmitted from the transmission/reception unit 10A, includes a breakage determination unit.

The breakage determination unit determines whether or not partial breakage has occurred in the endless chain 1, on the basis of the link length D measured at the present time and the initial link length D0, for the same measurement reference position RP. For example, the breakage determination unit determines whether or not partial breakage has occurred in the endless chain 1, on the basis of whether or not the ratio between the link length D measured at the present time and the initial link length D0 is greater than a predetermined value, for the same measurement reference position RP.

The difference calculator may calculate a difference between the link length D measured at the present time and the link length measured at the previous time, for the same measurement reference position RP, and the breakage determination unit may determine whether or not partial breakage has occurred in the endless chain 1, on the basis of the difference calculated by the difference calculator and the initial link length D0. Thus, the information amount of the link lengths to be stored in the storage 10C can be reduced, and whether or not partial breakage has occurred in the endless chain 1 can be determined with less information.

Regarding the determination method, for example, whether or not partial breakage has occurred in the endless chain 1 may be determined on the basis of whether or not the ratio between the difference calculated by the difference calculator and the initial link length D0 is greater than a predetermined value.

For example, the chain equipment A in the present invention may be a conveyance line for automobile. In such a situation, if the link length for which partial breakage has occurred in the endless chain 1 has an extension of about 2 to 3 mm due to partial breakage excluding extension due to wear, it is possible to more clearly discriminate between extension of the link length due to wear and extension of the link length due to partial breakage.

In a conveyance line for automobile, normally, the link lengths of links used in the endless chain 1 are 150 mm to 350 mm.

Therefore, for example, if the chain equipment A in the present invention is a conveyance line for automobile, and the predetermined value used for the determination as to the ratio between the difference calculated at the present time and the initial link length D0 is 0.005 or greater, it is possible to determine whether or not partial breakage has occurred in the endless chain 1, and preferably, the predetermined value is 0.008 or greater.

In the case of the configuration including the difference calculator as in the first breakage determination method, it is preferable to provide an automatic oil supplier for supplying oil to the endless chain 1 when the rate of change in the difference calculated by the difference calculator is a predetermined value or greater, in the chain equipment A.

Wear of the endless chain 1 is caused by the links sliding on each other. Therefore, as the coefficient of friction between the sliding portions increases, the amount of wear of the endless chain 1 also increases. As a result, the rate of change in the difference increases.

The coefficient of friction between the sliding portions is greatly influenced by the oil supply condition of the chain. Therefore, for example, when the rate of change in the difference is a predetermined value or greater, the automatic oil supplier supplies oil to the endless chain 1, whereby the rate of change in the difference can be kept substantially constant, and thus breakage is less likely to occur.

<Confirmation of Partial Breakage Detection of Endless Chain by Chain Abnormality Detection Device>

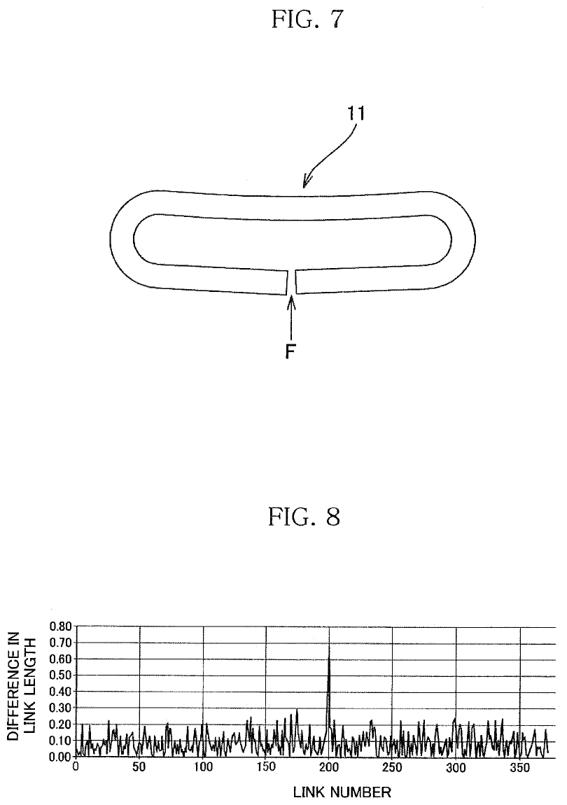

In the chain equipment A shown in the schematic plan view in FIG. 1, the center link 11 of a link number 200 in the endless chain 1 was partially broken (F in FIG. 7) on purpose as shown in a plan view in FIG. 7, and in this state, the chain abnormality detection device 10 performed breakage determination by the first breakage determination method.

As is found from a graph showing the relationship between each link number and the difference in the link length in FIG. 8, only the difference in the link length for the link number 200 is significantly greater than the differences in the link lengths for the other link numbers. Thus, partial breakage of the center link 11 as shown in FIG. 7 can be efficiently detected.

In this way, the length of the partial breakage F is included in the difference in the link length, thereby performing clear discrimination between extension of the link length due to wear and extension of the link length due to partial breakage.

The length of the partial breakage F changes depending on tension acting on the endless chain 1, and preferably, the chain abnormality detection device 10 is provided at a location where tension that allows clear discrimination between extension of the link length due to wear and extension of the link length due to partial breakage F to act, as described above.

Here, when breakage has not occurred in the link, the difference in the link length can be regarded as extension in the link length due to wear that corresponds to the link length measurement period. Normally, there are almost no variations among the wear amounts of the links of the endless chain 1, and therefore, theoretically, there are almost no variations among the differences in the link lengths of the links. However, as shown in the graph showing the relationship between each link number and the difference in the link length in FIG. 8, there may be variations overall among the differences in the link lengths, due to measurement error caused by vibration of the endless chain 1, or the like.

Therefore, preferably, the chain abnormality detection device 10 is provided at such a location that the length of the partial breakage F (extension in the link length due to partial breakage F) is greater than a difference between the greatest value and the smallest value of the differences in the link lengths calculated for the endless chain 1 in which no breakage has occurred in any link.

Thus, only the difference in the link length of the link having partial breakage F becomes significantly greater than the differences in the other link lengths, and it is possible to efficiently detect the partial breakage F.

In addition, the length of the side link 12 is also included in the link length D shown in FIG. 5 and FIG. 6, and therefore, even if there is partial breakage in any side link 12 instead of the center links 11, it is possible to detect the partial breakage in the same manner.

In the chain monitoring system according to the embodiment of the present invention as described above, the chain abnormality detection device 10 provided at the predetermined location on the circulation path C of the endless chain 1 in the chain equipment A has a compact and simple structure as shown in FIG. 3 to FIG. 6. Therefore, the installation space of the chain monitoring system is reduced, and increase in the manufacturing cost can be suppressed.

In addition, the reflection-type photoelectric sensor 21, the transmission-type photoelectric sensor 22, and the laser-type CCD length-measurement sensor 23, which are contactless sensors not in contact with the endless chain 1, are used as the sensors of the chain abnormality detection device 10. Therefore, increase in the maintenance cost can be also suppressed.

Furthermore, the chain abnormality detection device 10 includes the measurement start position detector 21, the reference position detector 22, and the distance measurement unit 23, and by these units, the link lengths of the endless chain 1 are sequentially measured for each link number in the ascending order from the link number 1, and whether or not partial breakage has occurred in the endless chain 1 is determined by the first breakage determination method or the second breakage determination method. Thus, it is possible to detect partial breakage of the center link 11 and partial breakage of a pair of upper and lower side links 12.

The description of the above embodiment is in all aspects illustrative and not restrictive. Various improvements and modifications can be made without departing from the scope of the present invention.

What is claimed is:

1. A chain monitoring system for chain equipment including an endless chain formed by connecting a plurality of links, and a drive device therefor, the chain monitoring system being configured to monitor a state of the endless chain by a chain abnormality detection device provided at a predetermined location on a predetermined circulation path while the endless chain is circulating along the predetermined circulation path,
the chain abnormality detection device including a measurement start position detector, a reference position detector, and a distance measurement unit,
the measurement start position detector being configured to detect that a measurement start position of the endless chain comes to a first predetermined position,
the reference position detector being configured to detect that one of measurement reference positions of the endless chain comes to a second predetermined position,
the distance measurement unit being configured to measure a distance from the measurement reference position to a subsequent measurement reference position, every time the reference position detector detects that the measurement reference position comes to the second predetermined position,
the chain monitoring system comprising:
a storage configured to store the distance measured by the distance measurement unit, for each of the measurement reference positions;
a difference calculator configured to calculate a difference between the distance measured at a present time and the distance measured at a previous time and/or a time prior thereto, for the same measurement reference position; and
a breakage determination unit configured to determine whether partial breakage has occurred in the endless chain, on the basis of the difference calculated by the difference calculator.

2. A chain monitoring system for chain equipment including an endless chain formed by connecting a plurality of links, and a drive device therefor, the chain monitoring system being configured to monitor a state of the endless chain by a chain abnormality detection device provided at a predetermined location on a predetermined circulation path while the endless chain is circulating along the predetermined circulation path,
the chain abnormality detection device including a measurement start position detector, a reference position detector, and a distance measurement unit,
the measurement start position detector being configured to detect that a measurement start position of the endless chain comes to a first predetermined position,
the reference position detector being configured to detect that one of measurement reference positions of the endless chain comes to a second predetermined position,
the distance measurement unit being configured to measure a distance from the measurement reference position to a subsequent measurement reference position, every time the reference position detector detects that the measurement reference position comes to the second predetermined position,
the chain monitoring system comprising:
a storage configured to store the distance measured by the distance measurement unit, for each of the measurement reference positions, and store an initial distance which is the distance when the endless chain initially circulates in the chain equipment; and
a breakage determination unit configured to determine whether partial breakage has occurred in the endless chain, on the basis of the distance measured at a present time and the initial distance, for the same measurement reference position.

3. The chain monitoring system according to claim 1, wherein
the chain abnormality detection device is provided at a location that is upstream of and near a tension maximum part where tension acting on the endless chain is maximized, in the endless chain.

4. The chain monitoring system according to claim 2, wherein
the chain abnormality detection device is provided at a location that is upstream of and near a tension maximum part where tension acting on the endless chain is maximized, in the endless chain.

5. The chain monitoring system according to claim 3, wherein
the chain abnormality detection device is provided at a location that is upstream of and near a driven part of the endless chain driven by the drive device, in the endless chain.

6. The chain monitoring system according to claim 4, wherein
the chain abnormality detection device is provided at a location that is upstream of and near a driven part driven by the drive device, in the endless chain.

7. The chain monitoring system according to claim 1, wherein
the endless chain includes:
center links which are oblong annular members or bar-shaped members each having, at front and rear ends, pin holes penetrating therethrough in a vertical direction;
pairs of upper and lower side links which are plate-shaped members each having, at front and rear ends, pin holes penetrating therethrough in the vertical direction; and
connection pins connecting the center links and the pairs of upper and lower side links, and
the measurement reference position is a front end of each of the center links.

8. The chain monitoring system according to claim 2, wherein
the endless chain includes:
center links which are oblong annular members or bar-shaped members each having, at front and rear ends, pin holes penetrating therethrough in a vertical direction;
pairs of upper and lower side links which are plate-shaped members each having, at front and rear ends, pin holes penetrating therethrough in the vertical direction; and
connection pins connecting the center links and the pairs of upper and lower side links, and
the measurement reference position is a front end of each of the center links.

9. The chain monitoring system according to claim 1, wherein
the breakage determination unit determines whether partial breakage has occurred in the endless chain, on the basis of a rate of change in the difference calculated by the difference calculator.

10. The chain monitoring system according to claim 3, wherein
the breakage determination unit determines whether partial breakage has occurred in the endless chain, on the basis of a rate of change in the difference calculated by the difference calculator.

11. The chain monitoring system according to claim 5, wherein
the breakage determination unit determines whether partial breakage has occurred in the endless chain, on the basis of a rate of change in the difference calculated by the difference calculator.

12. The chain monitoring system according to claim 7, wherein
the breakage determination unit determines whether partial breakage has occurred in the endless chain, on the basis of a rate of change in the difference calculated by the difference calculator.

13. The chain monitoring system according to claim 1, wherein
the chain equipment further includes an automatic oil supplier configured to supply oil to the endless chain when a rate of change in the difference calculated by the difference calculator is a predetermined value or greater.

14. The chain monitoring system according to claim 3, wherein
the chain equipment further includes an automatic oil supplier configured to supply oil to the endless chain when a rate of change in the difference calculated by the difference calculator is a predetermined value or greater.

15. The chain monitoring system according to claim 5, wherein
the chain equipment further includes an automatic oil supplier configured to supply oil to the endless chain when a rate of change in the difference calculated by the difference calculator is a predetermined value or greater.

16. The chain monitoring system according to claim 7, wherein
the chain equipment further includes an automatic oil supplier configured to supply oil to the endless chain when a rate of change in the difference calculated by the difference calculator is a predetermined value or greater.

17. The chain monitoring system according to claim 9, wherein
the chain equipment further includes an automatic oil supplier configured to supply oil to the endless chain when a rate of change in the difference calculated by the difference calculator is a predetermined value or greater.
